(19) United States
(12) Patent Application Publication
(10) Pub. No.: US 2017/0294093 A1
(43) Pub. Date: Oct. 12, 2017

(54) AUTOMATED WILDFIRE SUPPRESSION SYSTEM

(71) Applicants: Michael Fred Smith, Piedemont, OK (US); Tyler Alexander Hamm, Edmond, OK (US); Marcus Alexander Zajac, Edmond, OK (US); Jenifer Lynn Chamreun, Oklahoma City, OK (US); Jimmy Bollman, Oklahoma City, OK (US)

(72) Inventors: Michael Fred Smith, Piedemont, OK (US); Tyler Alexander Hamm, Edmond, OK (US); Marcus Alexander Zajac, Edmond, OK (US); Jenifer Lynn Chamreun, Oklahoma City, OK (US); Jimmy Bollman, Oklahoma City, OK (US)

(21) Appl. No.: 15/633,998

(22) Filed: Jun. 27, 2017

Related U.S. Application Data
(62) Division of application No. 14/959,035, filed on Dec. 4, 2015.

(51) Int. Cl. G08B 17/00; A62C 37/11; A62C 99/00; A62C 3/02

(52) U.S. Cl. CPC G08B 17/005; A62C 3/0271; A62C 3/0292; A62C 37/11; A62C 99/0072

(57) ABSTRACT

An automated wildfire suppression system configured to automatically alert homeowners and first responders when a fire approaches a perimeter of a protected area and to suppress or prevent the wildfire from burning the protected area. The automated wildfire suppression system generally includes a plurality of heat detectors arranged around the perimeter of the protected area coupled with a water sprinkler system and an automated alarm system. The heat detectors sense a pre-determined temperature increase or a predetermined fixed temperature indicative of a wildfire. Upon detection, the automated wildfire suppression system activates the sprinkler system and alarm system. Thus, preventing or slowing wildfires from reaching the protected area.

### CROSS REFERENCE TO RELATED APPLICATIONS

This application is a divisional of U.S. application Ser. No. 14/959,035 filed on Dec. 4, 2015.

### BACKGROUND

Wildfires destroy numerous homes in the United States each year costing home owners significant sums of money and leading to the death and injury of countless people. In addition, wildfires also destroy farmlands, crops, animals, wildlife and various other natural and manmade resources and structures. Wildfires can be caused by naturally occurring events, such as lightning, drought, and wind, for example. In addition, wildfires can be caused by non-naturally occurring events, such as improperly discarded cigarettes, campfires, electrical fires, and the like.

Dry areas are at increased risk for wildfire damage. Dry winds can spread wildfires quickly to nearby structures or property, sometimes within a matter of minutes. Wildfires that break out during droughts or water shortages may be particularly devastating to local environments, as there may not be sufficient water or other resources to stop or suppress the flames. Further, in some circumstances, the cost of bringing water and other resources to the wildfire may be cost prohibitive. Thus, leaving persons and property more susceptible to damage and loss.

Unlike fires that begin within a home or structure, wildfires that come from a source exterior to the property are difficult to predict and prevent. Wildfires often move and spread in unique patterns dependent upon specific environmental factors, such as wind speed, moisture, vegetation and geographic topography, for example. Often, property owners are not even present during the wildfire. Property owners may be at work or attending to various other obligations when a wildfire begins to approach the property. Even if present, property owners are often forced to abandon the property when the wildfire comes too near. For example, a local government may issue an evacuation order, in some circumstances, to alert property owners when a nearby fire poses a danger so as to protect the safety of people. Property owners are then forced to leave the property to the mercy of the fire without any system in place to protect the property.

First responders, such as firefighters, focus their work first on protecting people and containing the wildfire before turning to the protection of individual homes, structures, or farmland. Further, wildfires that approach structures, such as homes, from the outside, generally do not have fire alarm systems or fire suppression systems configured to notify firefighters or property owners or help prevent the spread of the wildfire before the wildfire reaches the property. Because of the size and speed of most wildfires, by the time the wildfire reaches the home, it is often too late for the structure or property to be saved.

To that end it would be advantageous to provide an improved automated wildfire suppression system configured to automatically alert homeowners and first responders when a fire reaches a perimeter of a protected area and to suppress or prevent the fire from burning the protected area. The improved automated wildfire suppression system generally includes a plurality of heat detectors arranged around a perimeter of a protected area and in communication with a water sprinkler system and an automated alarm system. The heat detectors sense a pre-determined increase in outside temperature or a fixed pre-determined temperature indicative of a wildfire. Upon detection, the sprinkler system and alarm system are automatically activated by the wildfire suppression system to spray water on the protected area and to notify first responders and property owners. Thus, helping to prevent or reduce the wildfire from reaching or burning the protected area. In some embodiments, the improved automated wildfire suppression system may also be configured to send automatic alerts and notifications to designated recipients and may be controlled remotely from one or more remote computers. Further, in some embodiments, the improved automated wildfire suppression system may be integrated with existing lawn watering systems and home alarm systems to maximize efficiency. It is to such an improved automated wildfire suppression system and to methods for using thereof that exemplary embodiments of the inventive concepts disclosed and claimed herein are directed.

### BRIEF DESCRIPTION OF THE SEVERAL VIEWS OF THE DRAWINGS

Like reference numerals in the figures represent and refer to the same or similar element or function. Implementations of the disclosure may be better understood when consideration is given to the following detailed description thereof. Such description makes reference to the annexed pictorial illustrations, schematics, graphs, drawings, and appendices. In the drawings:

FIG. 1 is a perspective view of an exemplary embodiment of an automated wildfire suppression system according to the inventive concepts disclosed herein.

FIG. 2 is a perspective view of an automated alarm system of the automated wildfire suppression system of FIG. 1.

FIG. 3 is a perspective view of a remote computer of the automated wildfire suppression system of FIG. 1.

FIG. 4 is an embodiment of an automated wildfire suppression system according to the inventive concepts disclosed herein.

FIG. 5 is a perspective view of a remote computer of the automated wildfire suppression system of FIG. 4.

FIG. 6 is a perspective view of an automated alarm system of the automated wildfire suppression system of FIG. 4.

### DETAILED DESCRIPTION OF EXEMPLARY EMBODIMENTS

Before explaining at least one embodiment of the inventive concepts disclosed herein in detail, it is to be understood that the inventive concepts are not limited in their application to the details of construction and the arrangements of the components or steps or methodologies set forth in the following description or illustrated in the drawings. The inventive concepts disclosed herein are capable of other embodiments or of being practiced or carried out in various ways. Also, it is to be understood that the phraseology and terminology employed herein is for the purpose of description and should not be regarded as limiting the inventive concepts claimed herein in any way.

In the following detailed description of embodiments of the inventive concepts, numerous specific details are set forth in order to provide a more thorough understanding of the inventive concepts. However, it will be apparent to one of ordinary skill in the art that the inventive concepts within the disclosure may be practiced without these specific details. In other instances, well-known features have not been described in detail to avoid unnecessarily complicating the instant disclosure.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed.

The notation “a-n” if appended to a reference numeral is intended as merely convenient shorthand to reference one, or more than one, and up to infinity, of the element or feature identified by the respective reference numeral (e.g., 100a-n). Similarly, a letter following a reference numeral is intended to reference an embodiment of the feature or element that may be similar, but not necessarily identical, to a previously described element or feature bearing the same reference numeral (e.g., 105, 105a, 105b, etc.). Such shorthand notations are used for purposes of clarity and convenience only, and should not be construed to limit the instant inventive concept(s) in any way, unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

The inventive concepts disclosed herein are generally directed to embodiments of an automated wildfire suppression systems. The automated wildfire suppression system is configured to automatically alert homeowners and first responders when a fire reaches a perimeter of a protected area and to suppress or prevent the fire from burning the protected area. The automatic wildfire suppression system generally includes a plurality of heat detectors arranged around a perimeter of a protected area and in communication with a water sprinkler system and an automated alarm system. The heat detectors sense a pre-determined increase in outside temperature or a fixed pre-determined temperature indicative of a wildfire. Upon detection, the sprinkler system and alarm system are automatically activated by the wildfire suppression system to s pray water and/or a fire retardant chemical on the protected area and to notify first responders and property owners.

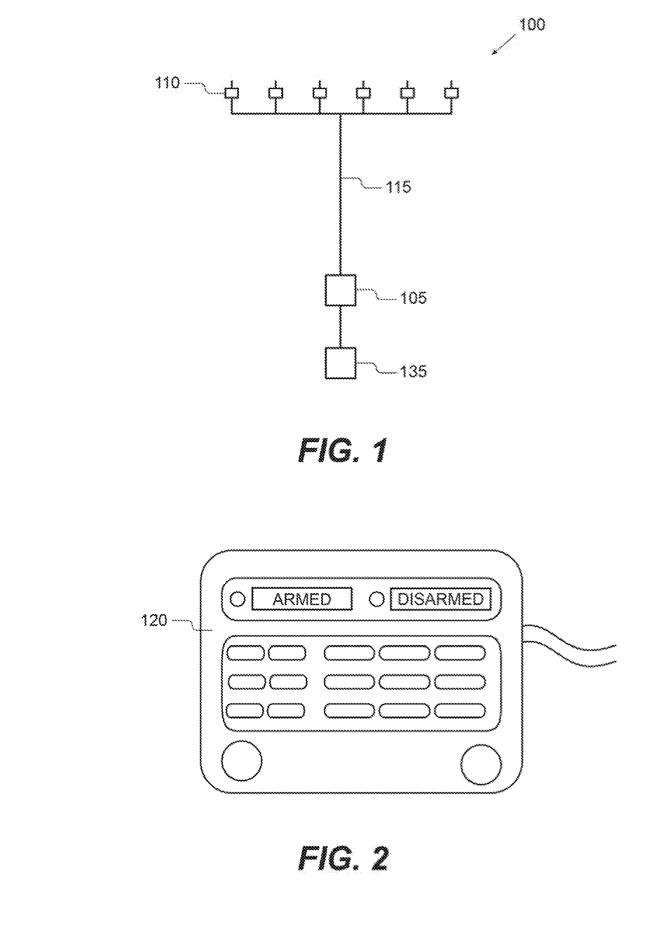

Referring now to FIGS. 1-3, shown therein is an exemplary embodiment of an automated wildfire suppression system 100 constructed according to the inventive concepts disclosed herein. The automated wildfire suppression system 100 includes a system controller 105 and at least one heat detection sensor 110 in communication with the system controller 105. The at least one heat detection sensor 110 for detecting a pre-determined outside temperature or a fixed pre-determined temperature and transmitting a first signal indicative of the pre-determined increase in outside temperature or fixed pre-determined temperature to the system controller 105. The automated wildfire suppression system 100 further includes an automated water distribution system 115 in communication with the system controller 105. The automated water distribution system 115 generally includes a plurality of sprinkler heads, pipe, and valves, such as solenoid valves, configured to automatically open and release the flow of water upon receipt of a signal from the system controller 105. The automated water distribution system 115 for spraying water upon receipt of a signal from the system controller 105 indicative of the pre-determined increase in temperature or fixed pre-determined temperature detected by the at least one heat detection sensor 110. The automated wildfire suppression system 100 further includes an automated alarm system 120 in communication with the system controller 105. The automated alarm system 120 for generating an alarm at a location remote from the at least one heat detection sensor 110 upon detection of the pre-determined increase in temperature or fixed pre-determined temperature by the heat detection sensor 110.

The system controller 105 is a computer or similar electronic device for storing, sending, receiving, and processing data, typically in binary form according to instructions given to it by a computer program. For example, the system controller 105 may be a computer constructed from an open-source platform, such as one manufactured by the company Arduino, that senses the environment by receiving input from sensors and that affects its surroundings by controlling actuators. The computer program for operating the system controller 105 may be written in Java, C+, or C++, or various other computer programming and source code languages known in the art. Computer programs to open or dose valves and to receive signals from various sensors, including heat detection sensors such as thermocouples, are well known in the art and will not be described in detail herein to avoid unnecessarily complicating the instant disclosure.

In operation, the system controller 105 receives a signal from the at least one heat detection sensor 110 indicative of the pre-determined increase in temperature or fixed pre-determined temperature and then sends a signal to one or more valves, such as solenoid valves configured to send and receive electronic signals, to open the valves and supply water to the sprinkler heads of the water distribution system 115. The sprinkler heads emit water at a fixed rate when the valve is open. The duration that the valve is open determines the volume of water supplied by the automated wildfire suppression system 100. Generally, the valves are configured to remain open for as long as the one or more heat detection sensors 110 detect a pre-determined increase in temperature or a fixed pre-determined temperature, thus ensuring that sufficient water is supplied to suppress or prevent the wildfire. However, it should be understood, that the duration and volume of water supplied by the automated wildfire suppression system 100 may be adjusted or modified to accommodate specific environmental conditions and wildfire threats.

The at least one heat detection sensor 110 is in communication with the system controller 105. The at least one heat detection sensor 110 may communicate electronically with the system controller 105 through wires, cables, or the like. Alternatively, the at least one heat detection sensor 110 may communicate electronically with the system controller 105 through a wireless communications network, such as through radio waves, WiFi, Bluetooth® and the like.

The at least one heat detection sensor 110 is configured to detect a pre-determined increase in outside temperature or a fixed pre-determined temperature and to transmit a signal indicative of the pre-determined increase in outside temperature or fixed pre-determined temperature to the system controller 105. Upon receipt of a signal from the at least one heat detection sensor 110 indicative of the pre-determined increase in outside temperature or the fixed pre-determined temperature, the system controller 105 transmits a signal to one or more valves, such as solenoid valves configured to send and receive electronic signals, to open and supply water through the sprinkler heads of the water distribution system 115.

The at least one heat detection sensor 110 is constructed from thermocouples configured to detect heat. Thermocouples are small metal rods attached to a wire that generate a current dependent on temperature. The thermocouples have two different conductors attached together. When there is a temperature difference the metals create a voltage that is read by the system controller 105 and then is registered as a different temperature.

In some embodiments, the thermocouples are configured to detect a fixed pre-determined temperature. Upon detection of a fixed pre-determined temperature the thermocouples then send a signal to the system controller 105 to open one or more valves of the water distribution system 115. Generally, the fixed pre-determined temperature is in a range of between approximately 130° F. and 190° F., and preferably between approximately 135° F. and 170° F. As one of ordinary skill in the art having the benefit of the instant disclosure will readily appreciate, however, the fixed pre-determined temperature required to open the one or more valves may be adjusted, up or down, to meet specific environmental conditions. For example, if the outside ambient temperatures is very hot and reaches temperatures above 120° F. the fixed pre-determined temperature may be adjusted up to be above 190° F., for example. Further, if the outside ambient temperature does not reach temperatures above freezing, the fixed pre-determined temperature may be adjusted down to be below 130° F., for example.

In some embodiments, the at least one heat detection sensor 110 is configured to detect a pre-determined increase or rate-of-rise in outside temperature instead of detecting a fixed pre-determined temperature. Rate-of-rise sensors activate upon a rapid rise in element temperature, generally a 12° F. to 15° F. (6.7° C. to 8.3° C.) increase per minute, irrespective of the starting temperature. This type of sensor can operate at lower temperature fire conditions than would otherwise be possible if the threshold were a fixed pre-determined temperature. Generally, a rate of rise sensor has two heat-sensitive thermocouples or thermistors. One thermocouple monitors heat transferred by convection or radiation. The other thermocouple responds to ambient temperature. A signal is transmitted to the system controller 105 when the first thermocouple detects a temperature increases relative to the second thermocouple.

As will be readily appreciated by one of ordinary skill in the art having the benefit of the instant disclosure, various types of heat detection sensors, such as rate-of-rise or fixed temperature heat detectors may be used consistent with the inventive concepts disclosed herein. Both fixed temperature and rate-of rise heat detectors are known in the art and will not be described in detail herein to avoid unnecessarily complicating the instant disclosure.

The automated wildfire suppression system 100 includes an automated water distribution system 115 in communication with the system controller 105. The automated water distribution system 115 generally includes a plurality of sprinkler heads, pipe, and valves such as solenoid valves, configured to automatically open and release the flow of water upon receipt of a signal from the system controller 105. In some embodiments, the system controller 105 communicates electronically with the valves via wires, cables, and the like, for example. In some embodiments, the system controller 105 communicates electronically with the valves wirelessly using radio waves, WiFi, Bluetooth®, and the like, for example.

The pipe for the automated water distribution system 115 may be formed from PVC pipe or any other similar piping material known in the art capable of transporting water. For example, the pipe may be formed from metals, plastics, non-metals, composite materials, combinations thereof, and the like. As will be appreciated by persons of ordinary skill in the art having the benefit of the instant disclosure the pipe may be constructed from any desired material sufficient to transport water for the purposes disclosed herein.

The pipe used to transport water and other fluids through the automated water distribution system 115 may be configured or oriented in any manner sufficient to spray water up on the protected area. For example, the automated water distribution system 115 may be configured with multiple zones and oriented in a generally linear shape, T shape, L shape, rectangular, square, or triangular shape. In some embodiments, each zone may contain a plurality of sprinkler heads separated or controlled by one or more valves, so as to surround a protected area or create a barrier to prevent the spread of a wildfire. As will be appreciated by persons of ordinary skill in the art having the benefit of the instant disclosure, the water distribution system 115 may have any desired shape or configuration sufficient to spray water up on the protected area. Further, in some embodiments, the automated water distribution system 115 may be constructed underground and implemented in combination with existing pipe and lawn water sprinkler systems. While in some embodiments the water distribution system 115 may be constructed above ground so that it may be more easily assembled and disassembled when needed.

The valves used with the water distribution system 115 are preferably solenoid valves. Solenoid valves are electromechanically operated valves controlled by an electric current through a solenoid. Generally, solenoid valves operate by using a diaphragm attached to an electromagnet. The solenoid is the electromagnetic part of the valve, and generally includes a coil, core tube, core, and enclosure. When a current is sent to the solenoid valve, the diaphragm is lifted up or down, depending upon how the solenoid valve is configured, allowing water to pass or causing the flow of water to stop.

As used with the automated water distribution system 115, the solenoid valve is configured to remain closed until the diaphragm is opened upon receipt of a signal that the at least one heat detection sensors 110 have detected the pre-determined increase in temperature or the fixed temperature indicative of a wildfire. Thus, the flow of water can be controlled by the system controller 105 of the automated water distribution system 100. Solenoid valves can be configured to have multiple ports to direct the flow of water. In the case of a two port valve the water flow is switched on or off and in the case of a three or more port valve the water flow is switched between multiple outlet ports. Solenoid valves and other similar valves for electronically controlling the flow of liquids are known in the art and will not be described in detail herein to avoid unnecessarily complicating the instant disclosure.

The automated water distribution system 115 is configured to transport water from a water source to a protected area that is to be sprayed down with water to suppress or prevent a wildfire. In operation, the sprayed water cools the burning material by conversion of liquid to vapor. The vapor displaces the oxygen supply and smothers the wildfire. The sprayed water also limits the supply of new fuel for the wildfire by moistening materials in the protected area. Further, the sprayed water cools the ambient temperature in the vicinity of the protected area helping to suppress the spread of the wildfire. Thus, creating a protective barrier around the perimeter of a protected area.

The automated water distribution system 115 sprays water upon receipt of a signal from the system controller 105 indicative of the pre-determined increase in temperature or fixed temperature detected by the at least one heat detection sensor 110. Upon detection of the pre-determined increase in temperature or the fixed temperature, the at least one heat detection sensor 110 sends a signal to the system controller 105 which in turn sends a current through the valve, such as a solenoid valve, of the water distribution system 115, causing water to flow through the sprinkler heads of the water distribution system 115.

As shown in FIG. 1, in some embodiments, the automated wildfire suppression system 100 further includes at least one device 135 for mixing a fire suppressant agent into the water that is sprayed from the automated water distribution system 115. The device 135 is a pump or other similar device, having an outlet configured to release a fire suppressant agent from the housing into the automated water distribution system 115 to further suppress or prevent the spread of the wildfire.

For example, in some embodiments, a dry or liquid chemical compound may be introduced into the automated water distribution system 115 to further reduce the spread of the wildfire. Fire suppressant agents based on mono ammonium phosphate, sodium bicarbonate, potassium bicarbonate, FireIce® non-toxic gels, and other similar chemical compounds, are known in the art. In some embodiments, the fire suppressant agent is mixed with the water at the point of the spray, such that the fire suppression agent may chemically react with the sprayed water to form a foam, gel, or other similar substance to help suppress or prevent of the fire. While in some embodiments, the fire suppression agent may be mixed with the water in the pipe so that the sprayed water contains a chemical mixture configured to suppress the wildfire. Further, in some embodiments, an antifreeze solution or other similar chemical compound may be used with the device 135 to prevent the water used in the water distribution system 115 from freezing. As will be readily appreciated by a person of ordinary skill in the art having the benefit of the instant disclosure, various types of chemical compounds, including fire suppressant agents, mixing agents, antifreeze solutions, and the like, may be introduced into the water distribution system 115 through the at least one device 135.

Referring now to FIG. 2, shown therein is an automated alarm system 120 of the wildfire suppression system 100 in communication with the system controller 105. The automated alarm system 120 is a computer or other similar device configured to activate an alarm at a location remote from the at least one heat detection sensor 110. In some embodiments, the automated alarm system 120 is activated by the system controller 105 to sound an alarm upon detection of a pre-determined increase in temperature indicative of a wildfire. While, in some embodiments, the automated alarm system 120 is activated by the system controller 105 to sound an alarm upon detection of a pre-determined fixed temperature indicative of a wildfire.

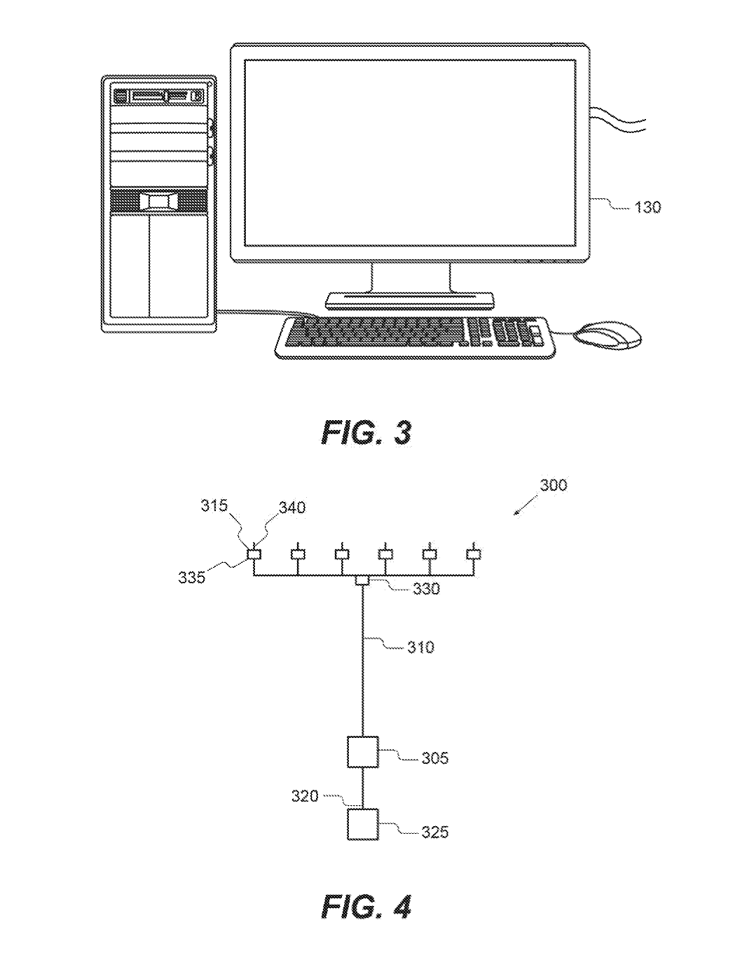

Referring now to FIG. 3, in some embodiments, the wildfire suppression system 100 further includes at least one remote computer 130. The at least one remote computer 130 is a computer, or similar electronic device, such as a cellular telephone, for example, configured for storing, sending, receiving, and processing data, typically in binary form, according to instructions given to it by a computer program. The at least one remote computer 130 is in communication with the system controller 105 and is positioned at a location separate from the system controller 105.

The at least one remote computer 130 is configured to remotely control the system controller 105 and thus control the automated wildfire suppression system 100. In some embodiments the at least one remote computer 130 controls the system controller 105 and automated wildfire suppression system 100 over the internet, worldwide web, or a local, private, or other secure data network. Preferably, the at least one remote computer 130 communicates with the system controller 105 through a ireless communications network. Wireless communications networks are known in the art and generally include any type of computer network that uses wireless data. Examples of wireless communications networks include, cell phone networks, Wi-Fi networks, Bluetooth®, terrestrial microwave or radio wave networks, and the like. It should be understood however, that in some embodiments, the at least one remote computer 130 may also communicate with the system controller 105 using ground or land wires or cables physically connected or partially physically connected between the at least one remote computer 130 and the system controller 105.

In operation, the at least one remote computer 105 permits a user or users to manage and control the settings of the automated wildfire suppression system 100 from a location remote from the automated wildfire suppression system 100. For example, a user may manually turn on or off the valves and sprinklers to stop or start the flow of water. A user may also pre-set the automated wildfire suppression system 100 to activate and spray water at a particular time or to activate a particular set zones to spray water. In this way, a user can monitor the spread of a wildfire from a remote location and activate and control the automated wildfire suppression system 100 from a safe location. The automated wildfire suppression system 100 may also be implemented with video cameras, GPS and satellite data, and other surveillance and monitoring equipment and data known in the art.

A user of the at least one remote computer 130 may interact with and control the settings of the automated wildfire suppression system 100 through the at least one remote computer 130. A user may input data into the at least one remote computer 130 and various computer programs running on the at lest one remote computer 130 using a keyboard, display monitor, or the like. For example, a user may input data such as a person's name, telephone number, and email address. The data may then be stored locally on the at least one remote computer 130 or may be stored at a location remote from the at least one remote computer 130. In some embodiments, the at least one remote computer 130 may be configured to send automatic alerts, texts, phone calls, and the like, upon an alarm being activated by the automated wildfire suppression system 100. For example, the at least one remote computer 130 may be configured to automatically contact or alert specific persons or organizations, such as the local fire department, police department, property owners, tenants, or other persons or organizations who may need to be notified upon activation of an alarm by the automated wildfire suppression system 100. Further, a user may also input security settings, such as passwords or other codes into the at least one remote computer 130 which may be used to restrict access to the automated wildfire suppression system 100.

Referring now to FIGS. 4-6, shown therein is an automated wildfire suppression system 300. The automated wildfire suppression system 300 may be implemented similarly, formed similarly and operated similarly to the automated wildfire suppression system 100 described above. The automated wildfire suppression system 300 includes a system controller 305 and an automated water distribution system 310 having at least one outlet 315 and at least one inlet 320. The at least one inlet 320 connected to a water supply source 325. At least one solenoid valve 330 connected to the automated water distribution system 310. The at I east one solenoid valve 330 controlled by the system controller 305 and configured to open upon receipt of a first signal transmitted from the system controller 305.

The automated wildfire suppression system 300 further includes at least one sprinkler head 335 connected to the at least one outlet 315 of the automated water distribution system 310. The at least one sprinkler head 335 configured to spray water on a protected area when the at least one solenoid valve 330 is open. The automated wildfire suppression system 330 also, includes at least one heat detection sensor 340 connected to the at least one sprinkler head 335. The at least one heat detection sensor 340 configured to detect a pre-determined increase in temperature and to transmit a signal to the system controller 305 upon detection of the pre-determined increase in temperature. Wherein upon receipt of the signal, the system controller 305 transmits a signal to the at least one solenoid valve 330 causing the solenoid valve 330 to open and permitting water to flow through the at least one sprinkler head 335 to spray water on the protected area.

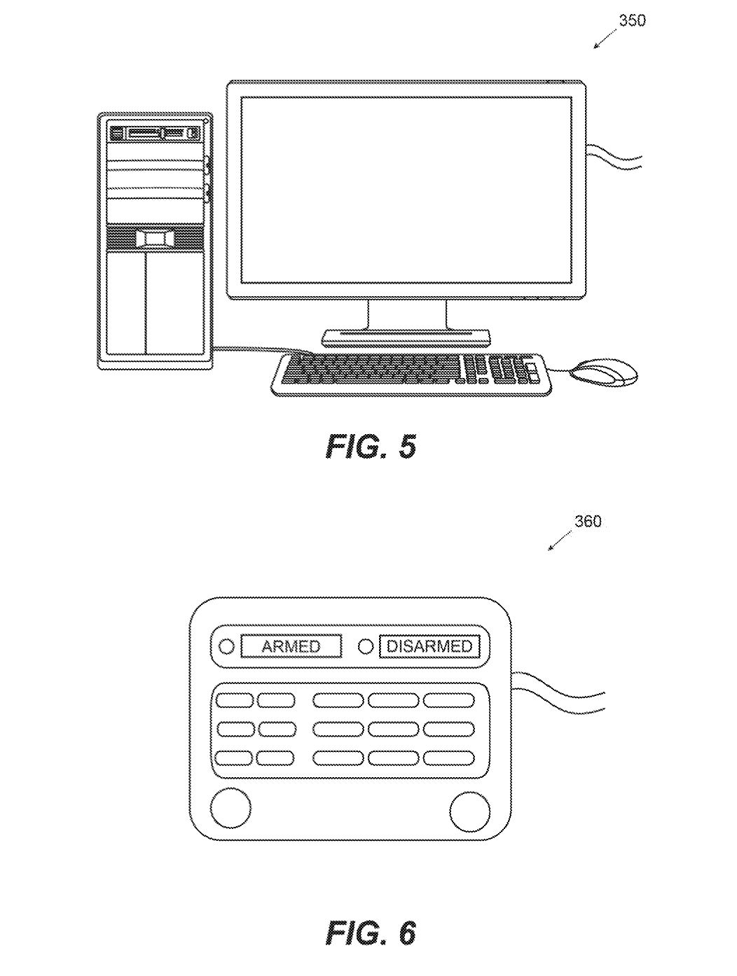

Referring now to FIG. 5 in some embodiments, the automated wildfire suppression system 300 further includes at least one remote computer 350. The at least one remote computer 350 may be implemented similarly, operated similarly, and formed similarly to the at least one remote computer 130 described above. The at least one remote computer 350 is in communication with the system controller 305 and is positioned at a location separate from the system controller 305. The at least one remote computer 350 configured for controlling the system controller 305 and the automated wildfire suppression system 300.

Referring now to FIG. 6, in some embodiments, the automated wildfire suppression system 300 further includes an automated alarm system 360. The automated alarm system 360 may be implemented similarly, operated similarly, and formed similarly to the automated alarm system 120 described above. The automated alarm system 360 is in communication with the system controller 305 and is positioned at a location separate from the system controller 305. The automated alarm system 360 is configured to generate an alarm upon detection of the pre-determined increase in temperature or pre-determined fixed temperature detected by the at least one heat detection sensor 340.

It is to be appreciated that embodiments of the automated fire suppression system 100 and automated fire suppression system 300 may be shipped fully or partially assembled, or fully or partially disassembled in the form of a kit, as will be readily appreciated by persons of ordinary skill in the art having the benefit of the instant disclosure.

From the above description, it is clear that the inventive concepts disclosed herein are adapted to carry out the objects and to attain the advantages mentioned herein as well as those inherent in the inventive concepts disclosed herein. While exemplary embodiments of the inventive concepts disclosed herein have been described for purposes of this disclosure, it will be understood that numerous changes may be made which will readily suggest themselves to those skilled in the art and which are accomplished within the broad scope of the inventive concepts disclosed herein and defined by the appended claims.

What is claimed is:

1. An automated wildfire suppression system comprising:
a system controller;
an automated water distribution system having at least one outlet and at least one inlet, the at least one in let connected to a water supply source;
at least one solenoid valve connected to the automated water distribution system, the at least one solenoid valve controlled by the system controller and configured to open upon receipt of a first signal transmitted from the system controller;
at least one sprinkler head connected to the at least one outlet of the automated water distribution system, the at least one sprinkler head configured to spray water on a protected area when the at least one solenoid valve is open; and
at least one heat detection sensor connected to the at least one sprinkler head, the at least one heat detection sensor configured to detect a pre-determined increase in temperature and to transmit a second signal to the system controller upon detection of the pre-determined increase in temperature;
wherein upon receipt of the second signal, the system controller transmits the first signal to the at least one solenoid valve causing the solenoid valve to open and permitting water to flow through the at least one sprinkler head to spray water on the protected area.

2. The automated wildfire suppression system of claim 1, further comprising at least one remote computer in communication with the system controller and positioned at a location separate from the system controller, the at least one remote computer for controlling the system controller.

3. The automated wildfire suppression system of claim 1, further comprising an automated alarm system in communication with the system controller and positioned at a location separate from the system controller, the automated alarm system configured to generate an alarm upon detection of the pre-determined increase in temperature detected by the at least one heat detection sensor.
